(19) United States
(12) Patent Application Publication
(10) Pub. No.: US 2026/0319400 A1
(43) Pub. Date: Oct. 15, 2026

(54) BELT DEVICE, IMAGE FORMING APPARATUS, MAINTENANCE SUPPORT METHOD, AND STORAGE MEDIUM

(71) Applicant: Konica Minolta, Inc., Tokyo (JP)

(72) Inventor: Toshiki HAYAMI, Tokyo (JP)

(21) Appl. No.: 19/463,723

(22) Filed: Jan. 29, 2026

(30) Foreign Application Priority Data
Feb. 5, 2025 (JP) 2025-017612

(51) Int. Cl. G03G 15/16; G03G 15/00; G06Q 10/20

(52) U.S. Cl. CPC G03G 15/1615; G03G 15/161; G03G 15/553; G06Q 10/20

(57) ABSTRACT

A belt device includes, an endless belt that is stretched over a plurality of rollers; a position sensor that senses a position of the belt in a width direction; and a hardware processor. The hardware processor, executes steering control in which the position is adjusted based on sensing data by the position sensor, grasps a state of the belt when the steering control is executed, and outputs that maintenance is necessary based on the grasped state of the belt.

### CROSS-REFERENCE TO RELATED APPLICATION

The entire disclosure of Japanese Patent Application No. 2025-017612, filed on Feb. 5, 2025, including description, claims, drawings and abstract is incorporated herein by reference.

### BACKGROUND OF THE INVENTION

### Technical Field

The present disclosure relates to a belt device, an image forming apparatus, a maintenance support method, and a storage medium.

### DESCRIPTION OF RELATED ART

Conventionally, an apparatus has been disclosed which detects a difference in a predetermined direction between an actual position and an original position of a marking printed on a surface of a photoreceptor belt, and in a case where it is determined that the marking does not conform to a threshold value, notifies necessity of maintenance (see Japanese Unexamined Patent Publication No. 2013-235266).

However, in the apparatus disclosed in Japanese Unexamined Patent Publication No. 2013-235266, there is a possibility that it is judged that maintenance is necessary even though the photoreceptor belt has not reached near the end of its life. In such a case, since unnecessary maintenance is performed, there is a problem in that unnecessary costs are generated. Furthermore, the above-described apparatus may judge that maintenance is not needed even though the life of the photoreceptor belt has expired. In such a case, there is a problem that although the steering control is performed, belt deviation occurs, damage or abnormality is sensed from a belt end portion, and the apparatus is stopped. As a result, adverse effects such as an increase in maintenance costs due to an occurrence of downtime and a dispatch of a service engineer are exerted.

### SUMMARY OF THE INVENTION

The present disclosure has been made in view of the above-described problem, and an object of the present disclosure is to reduce the possibility that maintenance related to a belt is performed at an unnecessary timing.

In order to solve the above problem, according to an aspect of the present disclosure, a belt device reflecting one aspect of the present disclosure includes, an endless belt that is stretched over a plurality of rollers; a position sensor that senses a position of the belt in a width direction; and a hardware processor, wherein the hardware processor, executes steering control in which the position is adjusted based on sensing data by the position sensor, grasps a state of the belt when the steering control is executed, and outputs that maintenance is necessary based on the grasped state of the belt.

According to another aspect of the present disclosure, an image forming apparatus reflecting one aspect of the present disclosure includes, an image former that includes an endless intermediate transfer belt that is rotationally driven when a toner image is transferred, and a transferer that transfers the toner image on the intermediate transfer belt onto a sheet, wherein the image former forms the toner image onto the sheet; and a fixer that fixes the toner image formed by the image former onto the sheet, wherein the image former includes the above- described belt device including the belt corresponding to the intermediate transfer belt.

According to another aspect of the present disclosure, a maintenance support method reflecting one aspect of the present disclosure is a maintenance support method for a belt device including an endless belt that is stretched over a plurality of rollers; and a position sensor that senses a position of the belt in a width direction, the method including: executing steering control in which the position is adjusted based on sensing data by the position sensor, grasping a state of the belt when the steering control is executed, and outputting that maintenance is necessary based on the grasped state of the belt.

According to another aspect of the present disclosure a storage medium reflecting one aspect of the present disclosure is a non-transitory computer-readable storage medium storing a program that causes a computer of a belt device including an endless belt that is stretched over a plurality of rollers, and a position sensor that senses a position of the belt in a width direction, to perform, executing steering control in which the position is adjusted based on sensing data by the position sensor, grasping a state of the belt when the steering control is executed, and outputting that maintenance is necessary based on the grasped state of the belt.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a diagram illustrating an entire configuration of an image forming apparatus;

FIG. 2 is a block diagram illustrating a schematic control configuration of the image forming apparatus;

FIG. 3 is a diagram illustrating a schematic configuration of a position detector;

FIG. 4 is a diagram illustrating a method of identifying a belt position;

FIG. 5 is a flowchart illustrating a flow of maintenance judging processing;

FIG. 6 is a graph showing a presence frequency at each position in a width direction of an intermediate transfer belt on a 40th day from a first day when the maintenance judging processing is started;

FIG. 7 is a flowchart illustrating a flow of the maintenance judging processing executed by the image forming apparatus according to a modification example;

FIG. 8 is a diagram showing an operation manner of a steering motor when forced steering control is performed; and

FIG. 9 is a graph illustrating an example of transition of a state of the intermediate transfer belt.

### DETAILED DESCRIPTION

Hereinafter, one or more embodiments of the present disclosure will be described with reference to the drawings. However, the scope of the invention is not limited to the disclosed embodiments.

Hereinafter, embodiments of the present disclosure will be described with reference to the drawings.

### Configuration of Image Forming Apparatus

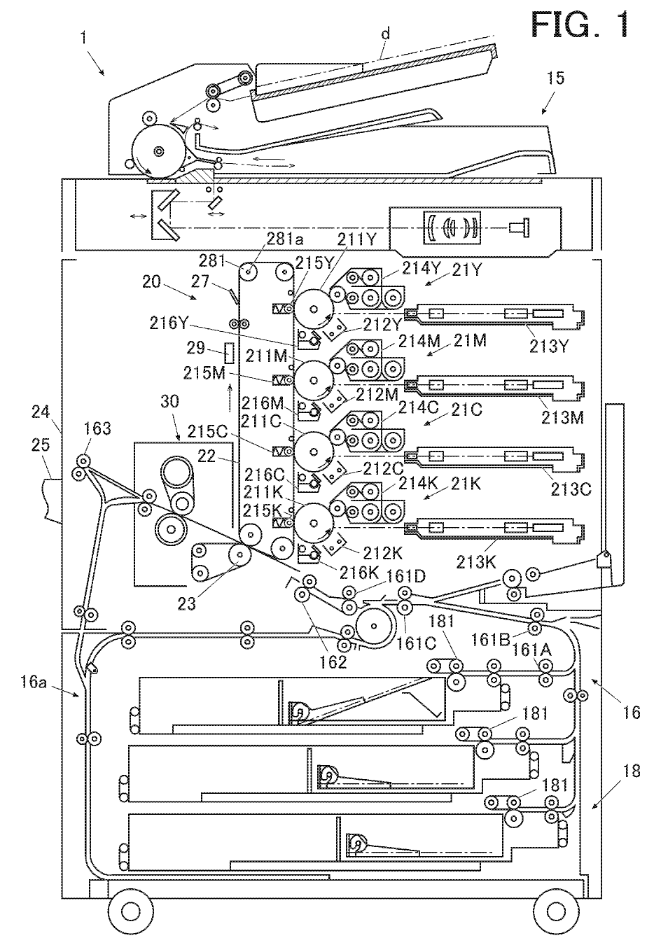

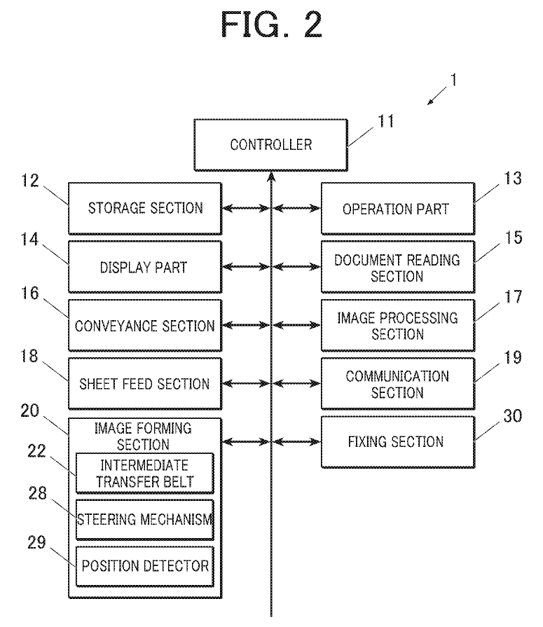

FIG. 1 is a diagram illustrating an overall configuration of an image forming apparatus 1 according to the present embodiment. FIG. 2 is a block diagram illustrating a schematic control configuration of the image forming apparatus 1.

As illustrated in FIGS. 1 and 2, the image forming apparatus 1 includes a controller 11, a storage section 12, an operation part 13, a display part 14, a document reading section 15, a conveyance section 16, an image

processing section 17, a sheet feed section 18, a communication section 19, an image forming section (image former) 20, and a fixing section (fixer) 30. The image forming apparatus 1 is an image forming apparatus such as a multifunction peripheral that forms an image on a sheet conveyed by a conveyance section 16 with an image forming section 20 and a fixing section 30.

The controller (hardware processor, control means, grasping means, output means) 11 is configured to include a CPU, a RAM, and a ROM, and controls each section of the image forming apparatus 1. The ROM is a storage section in which various programs and various data are stored. In the controller 11, the CPU reads various programs from the ROM, appropriately deploys the programs in the RAM, and executes various processes in cooperation with the deployed programs and the CPU. For example, the controller 11 causes the image processing section 17 to process a bitmap format original image which is generated by the document reading section 15 or received via the communication section 19 and held in the storage section 12. Next, the controller 11 causes the image forming section 20 to form the image on the sheet based on original image data after image processing.

The storage section 12 includes a dynamic random access memory (DRAM) or the like, and is an image memory that temporarily stores various types of data such as image data related to various types of image processing. Alternatively, the storage section 12 may be a configuration that includes a hard disk drive (HDD) or the like, and that stores various types of data in a readable and writable manner.

The operation part 13 and the display part 14 are provided in the image forming apparatus 1 as user interfaces. The operation part 13 generates an operation signal according to a user's operation and outputs the operation signal to the controller 11. As the operation part 13, a keypad, a touch screen integrally formed with the display part 14, or the like can be used. The display part 14 displays an operation screen or the like in accordance with an instruction from the controller 11. As the display part 14, a liquid crystal display (LCD), an organic electro luminescence display (OELD), or the like can be used.

The document reading section 15 is a scanner or the like provided for copying, and according to an instruction of the controller 11, reads a document d set on a document plate and generates an original image in a bitmap format having color values of red (R), green (G), and blue (B) for each pixel. An original image having color values of R, G, and B generated by the document reading section 15 is color-converted into an original image having color values of C, M, Y, and K by a color conversion unit (not shown), and then stored in the storage section 12.

The conveyance section 16 includes a plurality of conveyance rollers 161A, 161B, 161C, and 161D, a registration roller 162, and a sheet ejection roller 163. The conveyance section 16 conveys a sheet fed from the sheet feed section 18 or a manual sheet feed tray to the image forming section 20 and the fixing section 30 in accordance with an instruction from the controller 11, and discharges the sheet on which the image is formed and fixed from the sheet ejection port 24 to the sheet ejection tray 25. The ejected sheet is placed on the sheet ejection tray 25. Furthermore, the conveyance section 16 includes a reversing section 16a that reverses the sheet conveyed from the fixing section 30 and conveys the sheet again to the image forming section 20.

The image processing section 17 performs necessary image processing on the image data stored in the storage section 12, the image data obtained by reading the image from a document by the document reading section 15, and the image data input from an external device via the communication section 19, and outputs the image data after the image processing to the image forming section 20. The image processing includes gradation processing, halftone processing, color conversion processing, and the like. The gradation processing is processing for converting a gradation value of each pixel of the image data into the gradation value corrected such that concentration characteristics of the image formed on the sheet matches the target concentration characteristics. The halftone processing is error diffusion processing, screen processing using a systematic dither method, or the like. The color conversion processing is processing for converting each gradation value of RGB into each gradation value of CMYK.

The sheet feed section 18 includes a plurality of sheet feed trays, and supplies sheets to the image forming section 20 by a sheet feed unit 181 in accordance with an instruction from the controller 11. Each of the sheet feed trays stores sheets of a predetermined sheet type and size.

The communication section 19 is constituted by a network card or the like, and is connected to a network such as a local area network (LAN). The communication section 19 communicates with an external device on a network, for example, a user terminal such as a personal computer (PC), a server, or the like. The communication section 19 receives the image data for forming the image from the external device via the network.

The image forming section 20 forms the image of a plurality of colors of C, M, Y, and K on the sheet, based on the original image subjected to image processing by the image processing section 17, in accordance with the instruction from the controller 11. The image forming section 20 includes four writing units 21Y, 21M, 21C, and 21K, an intermediate transfer belt 22, a secondary transfer section (transferer) 23, a cleaning blade 27, a steering mechanism 28, and a position detector 29.

Four writing units 21Y, 21M, 21C and 21K are arranged in series (tandem) along a belt plane of the intermediate transfer belt 22 to form images in C, M, Y and K colors, respectively. The writing unit 21Y includes a photoreceptor 211Y, a charging section 212Y, an optical scanning device 213Y, a developing section 214Y, a primary transfer roller 215Y, and a cleaning section 216Y. At the time of image formation, in the writing unit 21Y, a voltage is applied to the photoreceptor 211Y by the charging section 212Y to charge the photoreceptor 211Y, and then the photoreceptor 211Y is scanned with a light beam emitted based on the original image by the optical scanning device 213Y to form an electrostatic latent image. When the developing section 214Y supplies a color material such as toner to develop the electrostatic latent image on the photoreceptor 211Y, a toner image is formed on the photoreceptor 211Y serving as an image bearing member. Note that each of the writing units 21M, 21C, and 21K is configured similarly to the writing unit 21Y, and therefore, description thereof is omitted.

In the respective writing units 21Y to 21K, when the toner images are formed on the photoreceptors 211Y to 211K, the toner images on the photoreceptors 211Y to 211K are sequentially transferred and superimposed onto the intermediate transfer belt 22 by the primary transfer rollers 215Y to 215K (primary transfer). Thus, the toner image formed of multiple colors is formed on the intermediate transfer belt 22. After the primary transfer, a color material remaining on the photoreceptors 211Y to 211K is removed by the cleaning sections 216Y to 216K.

The intermediate transfer belt (belt) 22 is an endless belt-shaped image bearing member that rotates by being wound around a plurality of rollers. The intermediate transfer belt 22 is rotationally driven at the time of transferring the toner image. The plurality of rollers include primary transfer rollers 215Y to 215K, a steering roller 281, and the like.

The secondary transfer section 23 is disposed on a conveyance route of the sheet conveyed from the sheet feed section 18. The secondary transfer section 23 transfers (secondarily transfers) the toner image on the intermediate transfer belt 22 onto the sheet fed from the sheet feed section 18, and conveys the sheet to the fixing section 30.

The cleaning blade 27 is provided between the secondary transfer section 23 and each writing unit 21 in a rotation direction of the endless intermediate transfer belt 22, and abuts on the outer surface of the intermediate transfer belt 22 to perform cleaning.

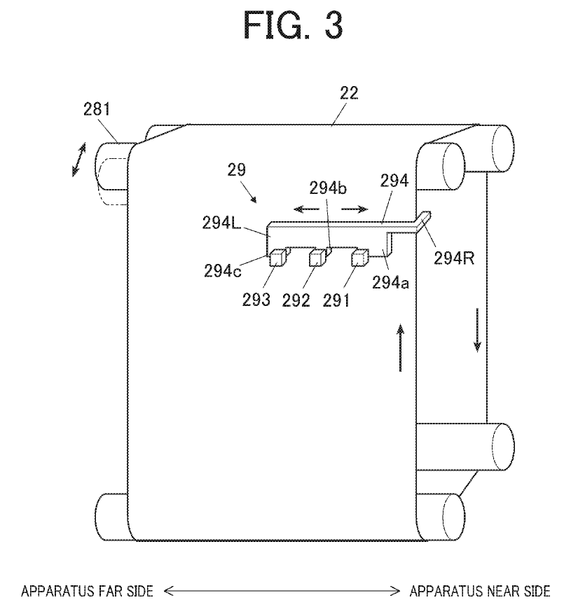

The steering mechanism 28 includes a steering roller 281 which is one of a plurality of rollers for stretching the intermediate transfer belt 22. The steering mechanism 28 adjusts the position of the intermediate transfer belt 22 in the width direction by inclining a rotation axis 281a of the steering roller 281 to move the intermediate transfer belt 22 in the width direction. Here, the width direction of the intermediate transfer belt 22 is an axis direction of a roller that stretches the intermediate transfer belt 22. As a result, meandering of the intermediate transfer belt 22 with respect to the width direction can be corrected. That is, deviation of the intermediate transfer belt 22 toward a far side of the apparatus (refer to FIG. 3) or the deviation of the intermediate transfer belt 22 toward the near side of the apparatus (refer to FIG. 3) can be corrected.

The position detector (position detection means) 29 detects the position of the intermediate transfer belt 22 in the width direction. Based on the position of the intermediate transfer belt 22 in the width direction detected by the position detector 29, the controller 11 executes the steering control for adjusting the position by the steering mechanism 28. Here, details of the position detector 29 will be described. As shown in FIG. 3, the position detector 29 includes a first photo sensor 291, a second photo sensor 292, a third photo sensor 293, and a movable member 294, which are disposed at predetermined positions along the width direction of the intermediate transfer belt 22. Each of the first photo sensor 291, the second photo sensor 292, and the third photo sensor 293 is, for example, a transmission-type photo sensor. The movable member 294 has one end portion 294R formed in a hook shape, and is in contact with a width direction end face of the intermediate transfer belt 22 at the end portion 294R. A bias spring (not illustrated) is attached to an end portion 294L of the movable member 294 opposite to the end portion 294R. The bias spring biases the movable member 294 toward the far side of the apparatus from the near side of the apparatus. By this biasing force, the movable member 294 follows the movement of the intermediate transfer belt 22 in the width direction in a state in which the end portion 294R is in contact with the end surface of the intermediate transfer belt 22. Note that a protection member may be attached to the end surface of the intermediate transfer belt 22 in order to improve durability. In addition, the protection member may be attached to the surface of the movable member 294 facing the intermediate transfer belt 22 in order to improve durability.

In addition, a first shielding section 294a, a second shielding section 294b, and a third shielding section 294c are provided at a lower portion of the movable member 294 so as to protrude downward. The first shielding section 294a, the second shielding section 294b, and the third shielding section 294c are spaced from each other by a predetermined interval in the width direction of the intermediate transfer belt 22.

The first photo sensor 291 is provided at a position facing the first shielding section 294a. When light emitted from a light emitting element is shielded by the first shielding section 294a, the first photo sensor 291 outputs, to the controller 11, information indicating a shielded state (L). On the other hand, when the light emitted from the light emitting element is not shielded by the first shielding section 294a, i.e., when the light is detected by a light receiving element, the first photo sensor 291 outputs information indicating a transmission state (H) to the controller 11.

The second photo sensor 292 is provided at a position facing the second shielding section 294b. When the light emitted from the light emitting element is shielded by the second shielding section 294b, the second photo sensor 292 outputs, to the controller 11, the information indicating the shielded state (L). On the other hand, when the light emitted from the light emitting element is not shielded by the second shielding section 294b, that is, when the light is detected by the light receiving element, the second photo sensor 292 outputs the information indicating the transmission state (H) to the controller 11.

The third photo sensor 293 is provided at a position facing the third shielding section 294c. When the light emitted from the light emitting element is shielded by the third shielding section 294c, the third photo sensor 293 outputs, to the controller 11, the information indicating the shielded state (L). On the other hand, when the light

emitted from the light emitting element is not shielded by the third shielding section 294c, that is, when the light is detected by the light receiving element, the third photo sensor 293 outputs, to the controller 11, the information indicating the transmission state (H).

The controller 11 identifies the position (belt position) of the intermediate transfer belt 22 in the width direction based on the information output from each of the first photo sensor 291, the second photo sensor 292, and the third photo sensor 293. Details of a method of identifying the belt position will be described later.

In accordance with an instruction from the controller 11, the fixing section 30 thermally fixes the image on the sheet on which the toner image as the color material image has been formed by the image forming section 20. That is, the fixing section 30 applies heat and pressure to the sheet on which the toner image has been formed by the image forming section 20. In a case of forming images on both sides of the sheet, the sheet having the image fixed on one side by the fixing section 30 is fed again to the position of the secondary transfer section 23 after the sheet surface is reversed by the reversing section 16a.

Note that the belt device according to the present disclosure includes at least the intermediate transfer belt 22, the position detector 29, the steering mechanism 28, and the controller 11.

### Method of Identifying Belt Position

Next, a method of identifying the belt position will be described.

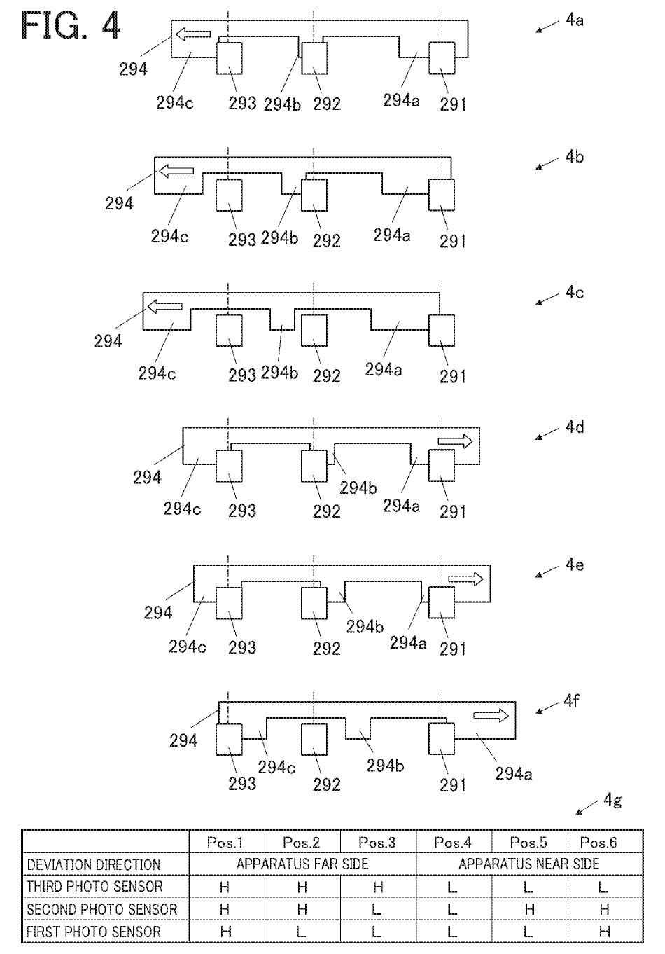

As illustrated in a table 4g of FIG. 4, width direction positions (Pos. 1 to Pos. 6) of the intermediate transfer belt 22 are set in advance according to the respective states (light shielding state (L) or the light transmission state (H)) of the first photo sensor 291, the second photo sensor 292, and the third photo sensor 293. Therefore, the controller 11 can identify the position of the intermediate transfer belt 22 in the width direction by acquiring the above-described information, that is, the information indicating the shielding state (L) or the information indicating the transmission state (H) from each of the photo sensors 291 to 293.

To be specific, when the first photo sensor 291 and the second photo sensor 292 are in the shielding state (L) and the third photo sensor 293 is in the transmission state (H), the controller 11 identifies that the position of the intermediate transfer belt 22 in the width direction is "Pos. 3" (see 4a and 4g in FIG. 4).

When the first photo sensor 291 is in the shielding state (L) and the second photo sensor 292 and the third photo sensor 293 are in the transmission state (H), the controller 11 identifies that the position of the intermediate transfer belt 22 in the width direction is "Pos. 2" (refer to 4b and 4g in FIG. 4).

When each of the first photo sensor 291, the second photo sensor 292, and the third photo sensor 293 is in the transmission state (H), the controller 11 identifies that the position of the intermediate transfer belt 22 in the width direction is "Pos. 1" (refer to 4c and 4g of FIG. 4). Here, the position at which the deviation (movement) of the intermediate transfer belt 22 toward the far side of the apparatus is the largest among Pos. 1 to Pos. 6 is Pos. 1. In other words, Pos. 1 is a position that interferes with image formation. Therefore, when the position of the intermediate transfer belt 22 in the width direction is identified as "Pos. 1", the controller 11 judges that it is in a state where a service engineer needs to be dispatched, and causes the display part 14 to display, for example, message information for requesting the dispatch of the service engineer.

When each of the first photo sensor 291, the second photo sensor 292, and the third photo sensor 293 is in the shielded state (L), the controller 11 identifies that the position of the intermediate transfer belt 22 in the width direction is at "Pos. 4" (refer to 4d and 4g in FIG. 4).

When the first photo sensor 291 and the third photo sensor 293 are in the shielded state (L) and the second photo sensor 292 is in the transmission state (H), the controller 11 identifies that the position of the intermediate transfer belt 22 in the width direction is at "Pos. 5" (see 4e and 4g in FIG. 4).

Further, when the third photo sensor 293 is in the shielding state (L) and the first photo sensor 291 and the second photo sensor 292 are in the transmission state (H), the controller 11 identifies that the position of the intermediate transfer belt 22 in the width direction is "Pos. 6" (see 4f and 4g in FIG. 4). Here, the position at which the deviation (movement) of the intermediate transfer belt 22 toward the near side of the apparatus is the largest among Pos. 1 to Pos. 6 is Pos. 6. In other words, Pos. 6 is a position that interferes with image formation. Therefore, when the position of the intermediate transfer belt 22 in the width direction is identified as "Pos. 6", the controller 11 judges that it is in a state where the service engineer needs to be dispatched, and causes the display part 14 to display, for example, the message information for requesting the dispatch of the service engineer.

### Maintenance Judging Processing

Next, maintenance judging processing for judging the necessity of maintenance for the intermediate transfer belt 22 and the steering mechanism 28 will be described. Here, the maintenance includes, for example, replacement of the intermediate transfer belt 22, replacement of the steering roller 281 or other rollers disposed on the inner surface of the intermediate transfer belt 22, and the like. The replacement of the rollers disposed on the inner surface of the intermediate transfer belt 22 may be performed by replacing all of the rollers or by replacing some of the rollers. The maintenance includes cleaning of the inner surface of the intermediate transfer belt 22, cleaning of rollers (including the steering roller 281) disposed on the inner surface of the intermediate transfer belt 22, and the like. Cleaning of the inner surface of the intermediate transfer belt 22 includes, for example, dry wiping with a cleaning material such as waste cloth. When the contamination is severe, a solvent such as isopropyl alcohol may be used. The cleaning of the roller disposed on the inner surface of the intermediate transfer belt 22 includes, for example, dry wiping with the cleaning material such as the waste cloth. When the contamination is severe, the solvent such as isopropyl alcohol may be used. The maintenance may be performed by a service engineer or a user.

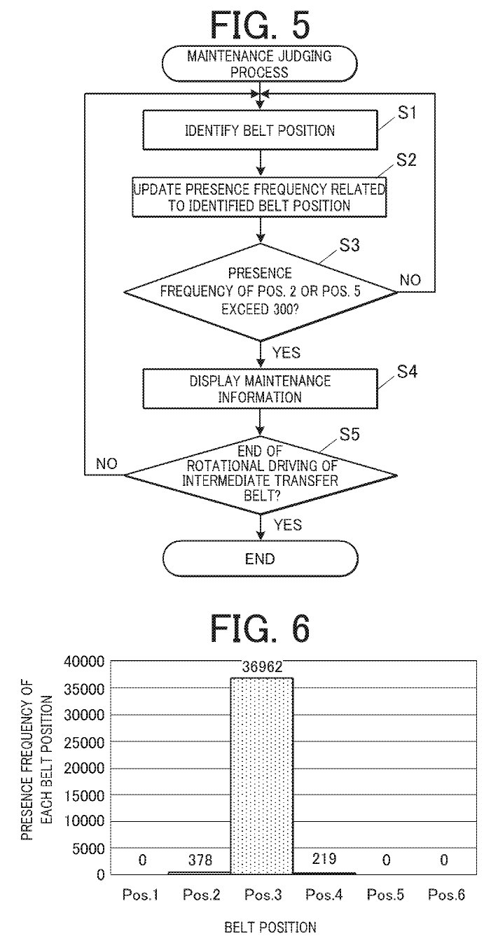

FIG. 5 is a flowchart illustrating a flow of maintenance judging processing; The maintenance judging processing is started, for example, when the intermediate transfer belt 22 starts to be rotationally driven under the control of the controller 11.

As illustrated in FIG. 5, when the maintenance judging processing is started, the controller 11 identifies the belt position, that is, the width direction position of the intermediate transfer belt 22 by the above-described identification method (step S1). Subsequently, the controller 11 updates the presence frequency of the intermediate transfer belt 22 related to the identified belt position based on the identified result of step S1 (step S2). That is, here, the controller 11 grasps the presence frequency as the state of the intermediate transfer belt 22. For example, when the belt position identified in step S1 is "Pos. 3", the controller 11 increments the presence frequency of "Pos. 3" of the intermediate transfer belt 22 by 1. Note that when the belt position identified in step S1 is "Pos. 1" or "Pos. 6", as described above, the controller 11 judges that it is in a state where the service engineer needs to be dispatched, and causes the display part 14 to display, for example, message information requesting the dispatch of the service engineer.

Next, the controller 11 determines whether the presence frequency related to "Pos. 2" or "Pos. 5" exceeded 300 or not (step S3). Here, in a case where maintenance of the intermediate transfer belt 22 or the steering mechanism 28 is performed, the presence frequency related to each of the belt positions of Pos. 1 to Pos. 6 is reset. For example, as illustrated in FIG. 6, in a case that the presence frequency of "Pos. 2" is greater than 300 from the first day when the maintenance judging processing is started to the 40th day, and the maintenance of the intermediate transfer belt 22 and the like is performed, the presence frequency "378" corresponding to "Pos. 2" is reset to "0". Similarly, the presence frequency “36962" of "Pos. 3" is reset to "0". Further, the presence frequency “219" of "Pos. 4" is reset to "0". Note that the presence frequency "300" that is a determination criterion of step S3 is merely an example. For example, in step S3, it may be determined whether or not the presence frequency of "Pos. 2" or "Pos. 5" exceeds 1.

Depending on the image forming apparatus 1, the intermediate transfer belt 22, and the steering mechanism 28, even immediately after the maintenance is performed, for example, the intermediate transfer belt 22 tends to shift to the far side of the apparatus. Therefore, the presence frequency (refer to FIG. 6) related to each of the belt positions of Pos. 1 to Pos. 6 immediately after the maintenance is performed may be stored as a state 1, and the determining processing in step S3 may be performed by a change from the state 1. In such a case, in step S3, a difference between the presence frequency of "Pos. 2" at the time when the process of step S3 is performed and the presence frequency of "Pos. 2" in the state 1 is calculated. Then, it is determined whether or not the calculated difference exceeds 300. Similarly, the difference between the presence frequency of "Pos. 5" at the time when the process of step S3 is performed and the presence frequency of "Pos. 5" in the state 1 is calculated. Then, it is determined whether or not the calculated difference exceeds 300.

Returning to FIG. 5, when it is determined in step S3 that the presence frequency of "Pos. 2" or "Pos. 5" does not exceed 300 (step S3; NO), the controller 11 returns the process to step S1 and repeats the subsequent processes. Here, it is assumed that the processing in step S1 is repeatedly performed, for example, at intervals of one second. Note that the presence frequency of the intermediate transfer belt 22 updated in step S2 may be outputted (e.g., displayed on the display part 14) on a daily basis so that the state of the intermediate transfer belt 22 can be analyzed.

In step S3, if it is determined that the presence frequency of "Pos. 2" or "Pos. 5" exceeds 300 (step S3; YES), the controller 11 allows the display part 14 to display maintenance information (step S4). Here, the maintenance information includes textual information, for example, "Perform maintenance of intermediate transfer belt.".

Next, the controller 11 determines whether the rotational drive of the intermediate transfer belt 22 has ended (step S5).

In step S5, when it is determined that the rotational drive of the intermediate transfer belt 22 has not ended (step S5; NO), the controller 11 returns the process to step S1 and repeats the subsequent processes. Further, in step S5, when it is determined that the rotational drive of the intermediate transfer belt 22 has ended (step S5; YES), the controller 11 finishes the maintenance judging process.

### Effects

As described above, the image forming apparatus 1 includes the endless intermediate transfer belt 22 stretched around a plurality of rollers. Further, the image forming apparatus 1 includes a position sensing section (position sensing means, position sensor) 29 for sensing the position of the intermediate transfer belt 22 with respect to the width direction. Further, the image forming apparatus 1 includes the steering mechanism 28 and the controller 11 that execute steering control for adjusting the position based on the sensing data obtained by the position sensing section 29. The controller 11 grasps the state of the intermediate transfer belt 22 when the steering control is executed, and outputs the necessity of maintenance related to the intermediate transfer belt 22 based on the grasped state of the intermediate transfer belt 22.

Therefore, according to the image forming apparatus 1, since the necessity of the maintenance related to the intermediate transfer belt 22 is output in consideration of the state of the intermediate transfer belt 22, it is possible to reduce the maintenance related to the intermediate transfer belt 22 from being performed at an unnecessary timing.

In addition, the controller 11 grasps the presence frequency of each position (Pos. 1 to Pos. 6) where the intermediate transfer belt 22 is present in the width direction of the intermediate transfer belt 22 as the state of the intermediate transfer belt 22.

Therefore, according to the image forming apparatus 1, since the sign of the belt deviation can be known from the presence frequency of each position (Pos. 1 to Pos. 6) where the intermediate transfer belt 22 is present, it is possible to appropriately grasp the state of the intermediate transfer belt 22.

Furthermore, when the presence frequency related to the predetermined position (Pos. 2 or Pos. 5) among the positions (Pos. 1 to Pos. 6) where the intermediate transfer belt 22 is present exceeds 300 (threshold value), the controller 11 outputs that maintenance is necessary.

Therefore, according to the image forming apparatus 1, in a case where the presence frequency related to the predetermined position (Pos. 2 or Pos. 5) exceeds 300, that is, in a case where the sign of the belt deviation appears, the necessity of the maintenance is output, and thus it is possible to perform the maintenance related to the intermediate transfer belt 22 at an appropriate timing.

### Modification Example

Next, the image forming apparatus 1A of a modification example will be described. The image forming apparatus 1A includes the feature in which the necessity of maintenance is judged on the basis of a moving time taken for the intermediate transfer belt 22 to move from one position to another position in a width direction of the intermediate transfer belt 22. Note that in the description of the image forming apparatus 1A according to the modification example, the same constituent elements as those of the embodiment described above are denoted by the same numerals, and the description thereof is omitted.

### Maintenance Judging Processing

The maintenance judging processing executed by the image forming apparatus 1A of the modification example will be described.

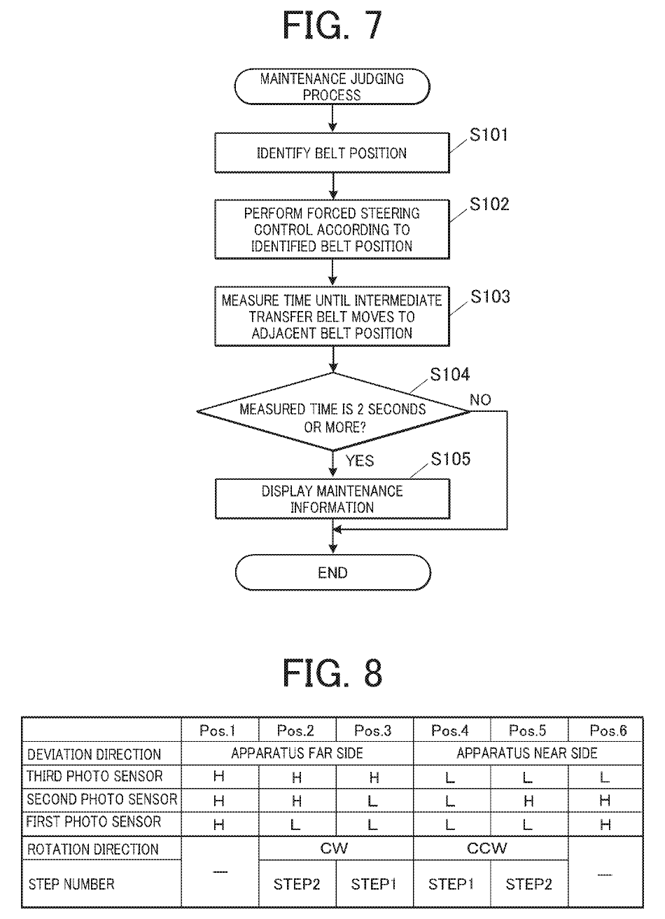

FIG. 7 is a flowchart showing a flow of a maintenance judging process executed by the image forming apparatus 1A according to the modification example. The maintenance judging processing is started, for example, when the image forming apparatus 1A is turned on and activated.

As illustrated in FIG. 7, when the maintenance judging processing is started, the controller 11 identifies the belt position, that is, the width direction position of the intermediate transfer belt 22 by the identification method described in the above-described embodiment (step S101). Subsequently, the controller 11 performs the forced steering control corresponding to the belt position identified in step S101 (step S102). To be specific, when the belt position identified in step S101 is "Pos. 2", the controller 11 performs the forced steering control in a state where the steering motor is operated in the forward rotation (CW) and in a predetermined number of steps (STEP2) (see FIG. 8). Furthermore, when the belt position identified in step S101 is "Pos. 3", the controller 11 performs the forced steering control in a state where the steering motor is operated in the forward rotation (CW) and in a predetermined number of steps (STEP1) (see FIG. 8). Here, the number of steps of the STEP1 is smaller than the number of steps of the STEP2. On the other hand, when the belt position identified in step S101 is "Pos. 5", the controller 11 performs the forced steering control in a state in which the steering motor is operated in the reverse direction (CCW) and by a predetermined number of steps (STEP2) (see FIG. 8). In addition, when the belt position identified in step S101 is "Pos. 4", the controller 11 performs the forced steering control in a state where the steering motor is operated in the reverse rotation (CCW) and the predetermined number of steps (STEP1) (refer to FIG. 8). Note that when the belt position identified in step S101 is "Pos. 1" or "Pos. 6", the controller 11 judges that it is in a state where the service engineer needs to be dispatched, and causes the display part 14 to display, for example, the message information requesting the dispatch of the service engineer.

Next, the controller 11 measures the time it takes for the intermediate transfer belt 22 to move from the belt position identified in step S101 to the adjacent belt position (step S103). That is, here, the controller 11 grasps the above time as the state of the intermediate transfer belt 22. To be specific, when the belt position identified in step S101 is "Pos. 2", the controller 11 measures the time until the belt position moves to "Pos. 3". When the belt position identified in step S101 is "Pos. 3", the controller 11 measures the time until the belt position moves to "Pos. 4". When the belt position identified in step S101 is "Pos. 4", the controller 11 measures the time until the belt position moves to "Pos. 3". When the belt position identified in step S101 is "Pos. 5", the controller 11 measures the time until the belt position moves to "Pos. 4".

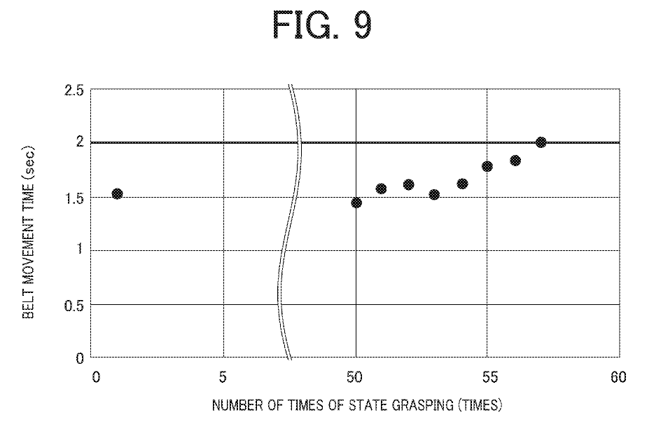

FIG. 9 is a graph illustrating an example of transition of the time (the state of the intermediate transfer belt 22) measured in step S103. A horizontal axis of the graph shown in FIG. 9 represents the number of times of execution of the maintenance judging process shown in FIG. 7, that is, the number of times of grasping the state of the intermediate transfer belt 22. A vertical axis of the graph shown in FIG. 9 represents the time (belt moving time) measured in step S103. As shown in FIG. 9, it is understood that the belt moving time becomes longer as the number of times of grasping the state increases. That is, it is found that as the number of times of grasping the state increases, the intermediate transfer belt 22 comes close to the end of life.

Returning to FIG. 7, next, the controller 11 determines whether or not the time measured in step S103 is two seconds or more (step S104). Note that the determination criterion of two seconds is merely an example and can be appropriately changed. In addition, in step S104, the time (for example, 1.53 seconds) measured in the maintenance judging process immediately after the maintenance is performed may be stored, and it may be determined whether or not the time measured in step S103 is increased by, for example, 30% or more from the stored time.

When it is determined in step S104 that the time measured in step S103 is not two seconds or more (step S104; NO), the controller 11 ends the maintenance judging processing. Here, in the example of the transition of the state of the intermediate transfer belt 22 illustrated in FIG. 9, it is determined in step S104 that the time measured in step S103 is not two seconds or more until the 56th maintenance judging processing (see FIG. 7).

Furthermore, if it is determined in step S104 that the time measured in step S103 is two seconds or more (step S104; YES), the controller 11 allows the display part 14 to display the maintenance information (step S105). Here, in the example of the transition in the state of the intermediate transfer belt 22 illustrated in FIG. 9, it is determined in the 57th maintenance judging processing (see FIG. 7) that the time measured in step S103 is two seconds or more. Then, the controller 11 ends the maintenance judging process. Here, the maintenance information includes textual information, for example, "Perform maintenance of intermediate transfer belt.".

### Effects

As described above, the controller 11 of the image forming apparatus 1A grasps, as the state of the intermediate transfer belt 22, the moving time taken for the intermediate transfer belt 22 to move from one position where the intermediate transfer belt 22 is present to another position close to the one position in the width direction of the intermediate transfer belt 22.

Therefore, according to the image forming apparatus 1A, whether or not the intermediate transfer belt 22 is in the steering uncontrollable state can be known from the above-described moving time, so that the state of the intermediate transfer belt 22 can be appropriately grasped.

Furthermore, the controller 11 of the image forming apparatus 1A grasps the moving time when the steering control is forcibly executed when the image is not formed.

Therefore, according to the image forming apparatus 1A, it is possible to appropriately identify whether or not the intermediate transfer belt 22 is in the steering uncontrollable state.

### Others

Note that the descriptions in the above embodiment and the above modification example are examples of the belt device, the image forming apparatus, the maintenance support method, and the program according to the present disclosure, and they are not limited thereto.

For example, in the above-described embodiment, the necessity of maintenance may be judged in stages, that is, at a plurality of levels in the maintenance judging process shown in FIG. 5. Specifically, when the presence frequency of "Pos. 2" or "Pos. 5" exceeds 150, the controller 11 judges that the necessity of maintenance is at a "caution level", and when the presence frequency exceeds 300, the controller judges that the necessity of maintenance is at a "warning level". Note that in the case of performing the determining processing in step S3 upon a change from the above-described state 1, it is judged that the necessity of maintenance is at the "caution level" when the calculated difference exceeds 150. In addition, in a case where the difference described above exceeds 300, it is judged that the necessity of maintenance is at the "warning level". In addition, when the determining processing of step S3 is performed by the change from the state 1 described above, in a case where the presence frequency related to "Pos. 2" or "Pos. 5" exceeds 200% from the state 1, it may be judged that the necessity of maintenance is in the "caution level". In addition, in a case where the presence frequency related to "Pos. 2" or "Pos. 5" exceeds 400% from the state 1, it may be judged that the necessity of maintenance is in the "warning level". Then, when it is judged that the necessity of maintenance is at the "caution level", caution message information (for example, "There is a possibility of occurrence of belt deviation. Please be aware of the state.") is displayed on the display part 14. Further, when it is judged that the necessity of maintenance is at the "warning level", warning message information (for example, "Perform maintenance of intermediate transfer belt.") is displayed on the display part 14.

Furthermore, in the modification example described above, the necessity of maintenance may be judged in stages, that is, at a plurality of levels in the maintenance judging processing illustrated in FIG. 7. To be specific, when the time measured in step S103 is 1.8 seconds or more and less than 2 seconds, it is judged that the necessity of maintenance is at the "caution level", and when the time is 2 seconds or more, it is judged that the necessity of maintenance is at the "warning level". Then, when it is judged that the necessity of maintenance is at the "caution level”, the caution message information (for example, "There is a possibility of occurrence of belt deviation. Please be aware of the state.") is displayed on the display part 14. Further, when it is judged that the necessity of maintenance is at the "warning level", the warning message information (for example, "Perform maintenance of intermediate transfer belt.") is displayed on the display part 14.

Further, in the above-described modification example, the timing at which the maintenance judging process shown in FIG. 7 is executed may be at least while the image is not formed, and is not limited to the timing at which the image forming apparatus 1A is turned on and activated. For example, it may be a timing such as at the time of starting printing, at the time of ending printing operation, or after being left for a certain amount of time.

Further, in the above-described modification example, in step S103 of the maintenance judging process shown in FIG. 7, for example, the time taken for the intermediate transfer belt 22 to move from the belt position judged in step S101 to the belt position adjacent in two positions (adjacent to the adjacent position) identified in step S101 may be measured. That is, the measurement target in step S103 is not limited to the time until the belt moves from the belt position identified in step S101 to the adjacent belt position.

Furthermore, in the embodiment and the modification example, the intermediate transfer belt 22 is given as an example of the endless belt according to the present disclosure, but the endless belt may be, for example, a secondary transfer belt of the secondary transfer section 23, a fixing belt of the fixing section 30, or a conveyance belt of the conveyance section 16. Provided that when these belts are targets, the image forming apparatus is provided with the position detection means for sensing of a position of the belt in the width direction and a steering mechanism for adjusting the position of the belt in the width direction.

In the embodiment and the modification example, the message information, the caution message information, and the warning message information may be transmitted to a server (for example, a service center) on a network via the communication section 19.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A belt device comprising:
an endless belt that is stretched over a plurality of rollers;
a position sensor that senses a position of the belt in a width direction; and
a hardware processor,
wherein the hardware processor,
executes steering control in which the position is adjusted based on sensing data by the position sensor,
grasps a state of the belt when the steering control is executed, and
outputs that maintenance is necessary based on the grasped state of the belt.

2. The belt device according to claim 1, wherein the hardware processor grasps, as the state, presence frequency of each position where the belt is present in the width direction.

3. The belt device according to claim 2, wherein the hardware processor outputs that the maintenance is necessary in a case in which the presence frequency related to a predetermined position among each position where the belt is present exceeds a threshold value.

4. The belt device according to claim 2, wherein the hardware processor outputs that the maintenance is necessary in a case in which a difference between the presence frequency immediately after executing the maintenance and the presence frequency thereafter exceeds a threshold value regarding the presence frequency related to a predetermined position among each position where the belt is present.

5. The belt device according to claim 1, wherein the hardware processor grasps, as the state, a moving time when the belt moves from one position where the belt is present in the width direction to another position near the one position.

6. The belt device according to claim 5, wherein the hardware processor grasps the moving time when the steering control is forcibly executed while an image is not formed.

7. The belt device according to claim 1, wherein the hardware processor, divides a necessity of the maintenance into a plurality of levels, and outputs a necessity of the maintenance for each of the levels.

8. An image forming apparatus comprising:
an image former that includes an endless intermediate transfer belt that is rotationally driven when a toner image is transferred, and a transferer that transfers the toner image on the intermediate transfer belt onto a sheet, wherein the image former forms the toner image onto the sheet; and
a fixer that fixes the toner image formed by the image former onto the sheet,
wherein the image former includes the belt device according to claim 1 including the belt corresponding to the intermediate transfer belt.

9. A maintenance support method for a belt device including an endless belt that is stretched over a plurality of rollers, and a position sensor that senses a position of the belt in a width direction, the method comprising:
executing steering control in which the position is adjusted based on sensing data by the position sensor,
grasping a state of the belt when the steering control is executed, and
outputting that maintenance is necessary based on the grasped state of the belt.

10. A non-transitory computer-readable storage medium storing a program that causes a computer of a belt device including an endless belt that is stretched over a plurality of rollers, and a position sensor that senses a position of the belt in a width direction, to perform,
executing steering control in which the position is adjusted based on sensing data by the position sensor,
grasping a state of the belt when the steering control is executed, and
outputting that maintenance is necessary based on the grasped state of the belt.
